(19) United States
(12) Patent Application Publication
(10) Pub. No.: US 2016/0275437 A1
(43) Pub. Date: Sep. 22, 2016

(54) PERSONNEL MANAGEMENT SYSTEM, INFORMATION ANALYSIS DEVICE, AND PERSONNEL MANAGEMENT METHOD

(71) Applicants: Kiyoshi SAWADA, Tokyo (JP); Kanji MITSUI, Tokyo (JP)

(72) Inventors: Kiyoshi SAWADA, Tokyo (JP); Kanji MITSUI, Tokyo (JP)

(21) Appl. No.: 15/066,292

(22) Filed: Mar. 10, 2016

(30) Foreign Application Priority Data
Mar. 20, 2015 (JP) 2015-057852

(51) Int. Cl. G06Q 10/06; G06K 7/10

(52) U.S. Cl. CPC G06Q 10/063114; G06K 7/10366

(57) ABSTRACT

A system includes oscillator carried by a worker to output an oscillator identifier by a radio wave; receivers each detecting the oscillator by the oscillator identifier and generating oscillator detection information by associating the oscillator identifier with a receiver identifier and timing information of receiving the radio wave, the receivers being arranged in places in a workplace for the worker; and an analysis device configured to manage an operation performance of the worker in the workplace on the basis of detection period information based on the oscillator detection information. The analysis device includes a noise removal processing unit configured to determine whether the worker has actually performed an operation in a workplace associated with the receiver on the basis of a length of the period, and remove, when determining that the worker has not actually performed the operation, the worker from an operation performance in the workplace.

### CROSS-REFERENCE TO RELATED APPLICATION

The present application claims priority to and incorporates by reference the entire contents of Japanese Patent Application No. 2015-057852 filed in Japan on Mar. 20, 2015.

### BACKGROUND OF THE INVENTION

1. Field of the Invention

The present invention relates to a personnel management system, an information analysis device, and a personnel management method.

2. Description of the Related Art

A method of managing personnel in a factory or the like by using radio frequency identifiers (RFIDs) has been proposed (see, for example, Japanese Laid-open Patent Publication No. 2002-247052). In Japanese Laid-open Patent Publication No. 2002-247052, IC tags are arranged in a matrix form under the floor of a workplace, and an RFID reader carried by a worker reads information on each of the IC tags and the behavior of the worker is traced.

In Japanese Laid-open Patent Publication. No. 2002-247052, an example is described in which workers carry RFID readers and IC tags are installed in the workplace. In contrast, if the number of workers increases, it may be possible to install RFID readers in the workplace and cause the workers to carry IC tags. In this case, to recognize the location of each of the workers, management performed based on which of the RFID readers has read the IC tag of each of the workers.

The aim of recognizing the locations of the workers is to accurately manage operations performed by the workers. Therefore, the locations of the workers are recognized based on which of the RFID readers has read the IC tag carried by each of the workers, and the operations performed by the workers are determined based on the locations of the workers.

However, there is a disadvantage in that the movement of the workers is recognized with high frequency. For example, if the IC tag is detected at a position where a worker has only passed while moving in the workplace, a system recognizes that an operation is performed at the position. However, the operation is not actually performed, and therefore, false information is recognized.

Therefore, there is a need to improve the accuracy of a detection result in a system that detects a location of a worker through wireless communication.

### SUMMARY OF THE INVENTION

It is an object of the present invention to at least partially solve the problems in the conventional technology.

According to an embodiment, there is provided a personnel management system that includes a radio wave oscillator having a function to output an oscillator identifier for identifying the radio wave oscillator by a radio wave, the radio wave oscillator being carried by a worker; a plurality of receivers, each having a function to detect the oscillator by acquiring the oscillator identifier by receiving the radio wave and to generate oscillator detection information by associating the oscillator identifier with a receiver identifier for identifying the receiver and timing information indicating a timing of receiving the radio wave, the plurality of receivers being arranged in a plurality of places in a workplace where the worker performs an operation; and an information analysis device configured to manage an operation performance of the worker in the workplace on the basis of detection period information that is obtained based on the oscillator detection information and that indicates a period in which the oscillator is continuously detected by the receiver. The information analysis device includes a noise removal processing unit configured to determine whether the worker carrying the oscillator detected in the period has actually performed an operation in a workplace associated with the receiver that has detected the oscillator in the period, on the basis of a length of the period included in the detection period information, and remove, when determining that the worker has not actually performed the operation, the worker from an operation performance in the workplace; and an information analyzing unit configured to analyze the detection period information subjected to the noise removal process, and manage an operation performance of the worker.

According to another embodiment, there is provided an information analysis device that operates in a personnel management system. The personnel management system includes a radio wave oscillator having a function to output an oscillator identifier for identifying the radio wave oscillator by a radio wave and being carried by a worker, and a plurality of receivers, each having a function to detect the oscillator by acquiring the oscillator identifier by receiving the radio wave and to generate oscillator detection information by associating the oscillator identifier with a receiver identifier for identifying the receiver and timing information indicating a timing of receiving the radio wave, the plurality of receivers being arranged in a plurality of places in a workplace where the worker performs an operation, the personnel management system being configured to manage an operation performance of the worker in the workplace. The information analysis device includes a detection period information acquiring unit configured to acquire detection period information, which is obtained based on the oscillator detection information and which indicates a period in which the oscillator is continuously detected by the receiver; a noise removal processing unit configured to determine whether the worker carrying the oscillator detected in the period has actually performed an operation in a workplace associated with the receiver that has detected the oscillator in the period, on the basis of a length of the period included in the detection period information, and removes, when determining that the worker has not actually performed the operation, the worker from an operation performance in the workplace; and an information analyzing unit configured to analyze the detection period information subjected to the noise removal process, and manage an operation performance of the worker.

According to still another embodiment, there is provided a personnel management method that includes detecting a radio wave oscillator carried by a worker by acquiring an oscillator identifier for identifying the oscillator by receiving a radio wave emitted by the oscillator; generating oscillator detection information by associating the acquired oscillator identifier with a receiver identifier for identifying a receiver that has received the radio wave and timing information indicating a timing of receiving the radio wave; acquiring detection period information that is obtained based on the oscillator detection information and that indicates a period in which the oscillator is continuously detected by the receiver; determining whether the worker carrying the oscillator detected in the period has actually performed an operation in a workplace associated with the receiver that has detected the oscillator in the period, on the basis of a length of the period included in the detection period information; performing a noise removal process of removing the worker from an operation performance in the workplace when it is determined that the worker has not actually performed the operation at the determining; and managing an operation performance of the worker by analyzing the detection period information subjected to the noise removal process.

The above and other objects, features, advantages and technical and industrial significance this invention will be better understood by reading the following detailed description of presently preferred embodiments of the invention, when considered in connect on with the accompanying drawings.

### BRIEF DESCRIPTION OF THE DRAWINGS

FIG. 1 is a diagram illustrating an operation mode of a system according to an embodiment of the present invention;

FIG. 2 is a block diagram illustrating a hardware configuration of an information processing apparatus according to the embodiment of the present invention;

FIG. 3 is a diagram illustrating an example of arrangement of antennas and a distribution of detection ranges according to the embodiment of the present invention;

FIG. 4 is a sequence diagram illustrating the entire operation of the system according to the embodiment of the present invention;

FIG. 5 is a diagram illustrating an example of primary information transmitted from an antenna to a server according to the embodiment of the present invention;

FIG. 6 is a diagram illustrating a location table indicating arrangement of antennas according to the embodiment of the present invention;

FIG. 7 is a diagram illustrating a user table indicating information on users according to the embodiment of the present invention;

FIG. 8 is a diagram illustrating an example of converted information obtained by converting an antenna ID in the primary information according to the embodiment of the present invention;

FIG. 9 is a diagram illustrating an example of stay information obtained based on the converted information according to the embodiment of the present invention;

FIG. 10 is a flowchart of operation of generating secondary information based on the converted information according to the embodiment of the present invention;

FIG. 11 is a diagram illustrating an example of in-process information that is primarily generated in the operation of generating the secondary information according to the embodiment of the present invention;

FIG. 12 is a diagram illustrating an example of the secondary information according to the embodiment of the present invention;

FIG. 13 is a flowchart illustrating a noise removal operation based on the secondary information according to the embodiment of the present invention;

FIG. 14 is a diagram illustrating an example in which a noise removal process is performed based on the secondary information according to the embodiment of the present invention;

FIG. 15 is a diagram illustrating an example of the secondary information according to the embodiment of the present invention;

FIG. 16 is a diagram illustrating an example in which the noise removal process is performed based on the secondary information according to the embodiment of the present invention;

FIG. 17 is a diagram illustrating an example of performance information according to the embodiment of the present invention;

FIG. 18 is a diagram illustrating an example of a product table according to the embodiment of the present invention;

FIG. 19 is a diagram illustrating an example of plan information according to the embodiment of the present invention;

FIG. 20 is a diagram illustrating an example of an analysis result report according to the embodiment of the present invention;

FIG. 21 is a diagram illustrating an example of actual line stop information according to the embodiment of the present invention;

FIG. 22 is a block diagram illustrating a functional configuration of an information analysis server according to the embodiment of the present invention;

FIG. 23 is a diagram illustrating an example of the in-process information on a plurality of tag IDs according to the embodiment of the present invention;

FIG. 24 is a diagram illustrating an aggregate result of the in-process information on a plurality of the tag IDs according to the embodiment of the present invention;

FIG. 25 is a diagram illustrating an example of a status display screen according to the embodiment of the present invention;

FIG. 26 is a diagram illustrating an example of line abnormality notification information according to the embodiment of the present invention;

FIG. 27 is a diagram illustrating an example of the status display screen according to the embodiment of the present invention;

FIG. 28 is a flowchart illustrating the operation of generating the secondary information and a noise removal operation based on the converted information according to the embodiment of the present invention;

FIG. 29 is a diagram illustrating an example of the secondary information according to the embodiment of the present invention;

FIG. 30 is a diagram illustrating an example in which the noise removal process is performed based on the secondary information according to the embodiment of the present invention;

FIG. 31 is a diagram illustrating an example in which the noise removal process is performed based on the secondary information according to the embodiment of the present invention;

FIG. 32 is a diagram illustrating an example of a removed record according to the embodiment of the present invention; and

FIG. 33 is a diagram illustrating an example of operation efficiency information according to the embodiment of the present invention.

### DETAILED DESCRIPTION OF THE PREFERRED EMBODIMENTS

Exemplary embodiments of the present invention will be described in detail below with reference to the accompanying drawings. In the embodiments, a personnel management system that manages locations of workers in a workplace, such as a factory, in chronological order will be described as an example. In this system, one of the features of the embodiment is to improve the accuracy of detection of the locations of the workers.

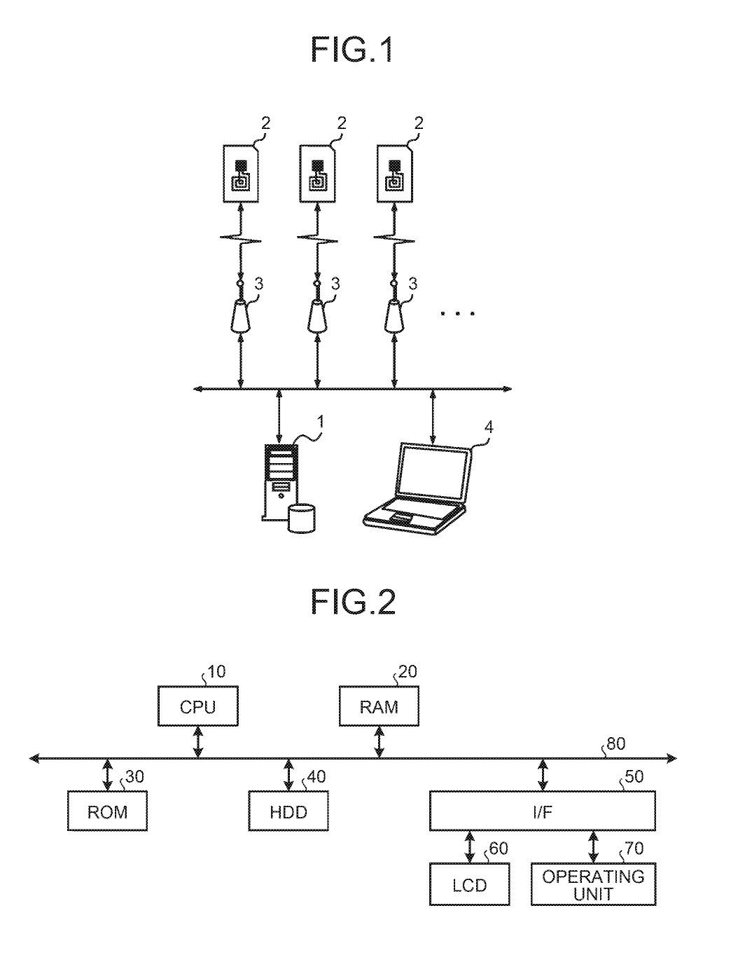

FIG. 1 is a diagram illustrating an operation mode of a personnel management system according to an embodiment. As illustrated in FIG. 1, the personnel management system according to the embodiment includes an information analysis server 1, a plurality of IC tags 2, a plurality of antenna devices 3, and an operator terminal 4. Each of the antenna devices 3 and the information analysis server 1 are connected via a network.

The IC tag 2 is a radio wave oscillator carried by each of workers, and transmits a tag ID associated with a user ID for identifying each of the workers with a predetermined cycle. The antenna device 3 is a radio wave receiver, and transmits, to the information analysis server 1, the tag ID that is received from the IC tag 2 via radio waves, an antenna ID for identifying each of the antenna devices 3, and information on a timing of receiving the tag ID. The antenna ID is a receiver identifier for identifying the antenna device 3 serving as the receiver. The antenna devices 3 are arranged at a plurality of positions in a workplace in which the personnel management system according to the embodiment is applied.

The information analysis server 1 is an information analysis device that recognizes the location of each of the workers in chronological order on the basis of information received from each of the antenna devices 3, and performs an information analysis, such as aggregation of operation performances or a comparison with a plan. The operator terminal 4 is a terminal operated by an operator who manages the personnel management system according to the embodiment, and is implemented by a general information processing terminal, such as a personal computer (PC). The operator operates the operator terminal 4 to input information in the information analysis server 1 or to view information generated by the information analysis server 1.

A hardware configuration of an information processing apparatus of the information analysis server and the antenna device 3 according to the embodiment will be described below with reference to FIG. 2. As illustrated in FIG. 2, the information processing apparatus according to the embodiment includes the same components as those of a general server, a general PC, or the like.

Specifically the information processing apparatus according to the embodiment includes a central processing unit (CPU) 10, a random access memory (RAM) 20, a read only memory (ROM) 30, a hard disk drive (HDD) 40, and an interface (I/F) 50, all of which are connected to one another via a bus 80. A liquid crystal display (LCD) 60 and an operating unit 70 are connected to the I/F 50.

The CPU 10 is an arithmetic unit and controls the entire operation of the information processing apparatus. The RAM 20 is a volatile storage medium that allows information to be read and written at high speed, and is used as a work area when the CPU 10 processes information. The RUM 30 is a read-only non-volatile storage medium, and stores therein a program of firmware or the like. The HDD 40 is a non-volatile storage medium that allows information to be read and written, and stores therein an operating system (OS), various control programs, application programs, and the like.

The I/F 50 connects the bus 80 with various kinds of hardware, networks, and the like, and controls the connected components. In each of the antenna devices 3, the antenna that receives radio waves emitted by the IC 2 is implemented as the I/F 50. The LCD 60 is a visual user interface for displaying various kinds of information. The operating unit 70 is a user interface, such as a keyboard, a mouse, a touch panel, or a hard key, used by a user to input information in the information processing apparatus. The information analysis server 1 is operated as a server; therefore, the user interfaces, such as the LCD 60 and the operating unit 70, may be omitted.

In the hardware configuration as described above, the CPU 10 performs calculations in accordance with a program stored in the ROM 30 or a program loaded from the HDD 40 or a storage medium (not illustrated), such as an optical disk, to the RAM 20, so that a software control unit is constructed. By a combination of the software control unit constructed as described above and the hardware, the information analysis server 1 and the antenna devices 3 according to the embodiment are constructed.

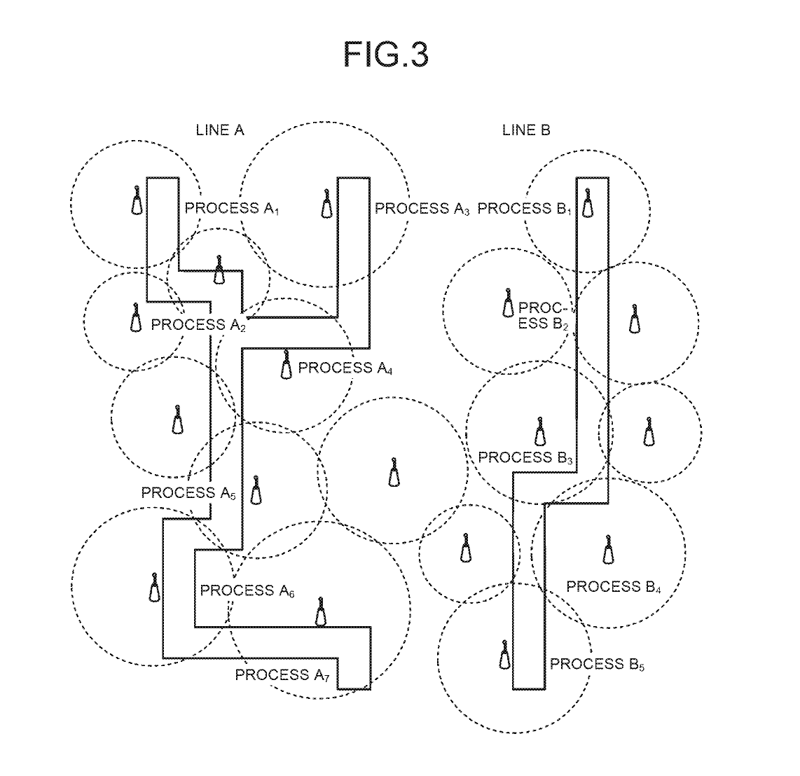

FIG. 3 is a diagram illustrating an example of arrangement of the antenna devices 3 and radio reception ranges of the antenna devices 3 in the workplace in which the personnel management system according to the embodiment is applied. The personnel management system according to the embodiment is applied to a factory in which products are manufactured on a plurality of production lines. In FIG. 3, a line A and a line B are illustrated.

In FIG. 3, routes of the production lines are indicated by bold lines. The line A includes seven processes from a process A1 to a process A7, and the line B includes five processes from a process B1 to a process B5. As illustrated in FIG. 3, operations of a plurality of processes are performed in a plurality of places on the line. To detect the IC tags carried by workers engaged in the respective processes, the antenna devices 3 are arranged in a plurality of places in the factory.

In FIG. 3, the reception ranges of the antenna devices 3 for receiving radio waves emitted by the IC tag 2 are indicated by dashed line circles centered at the respective antenna devices 3. The antenna devices 3 are arranged such that each of all areas in a range in which the workers perform operations in the factory can be covered by the reception range of any of the antenna devices 3. As indicated by the sizes of the dashed line circles in FIG. 3, it is possible to adjust the reception range of each of the antenna devices 3.

With the arrangement of the antenna devices 3 as illustrated in FIG. 3, when a worker carrying the IC tag 2 performs an operation, any of the antenna devices 3 receives the tag ID transmitted from the IC tag 2 carried by the worker. Based on the position of the antenna device 3 that has received the tag ID as described above, it is possible to recognize the location of a user who carries the IC tag whose tag ID has been received.

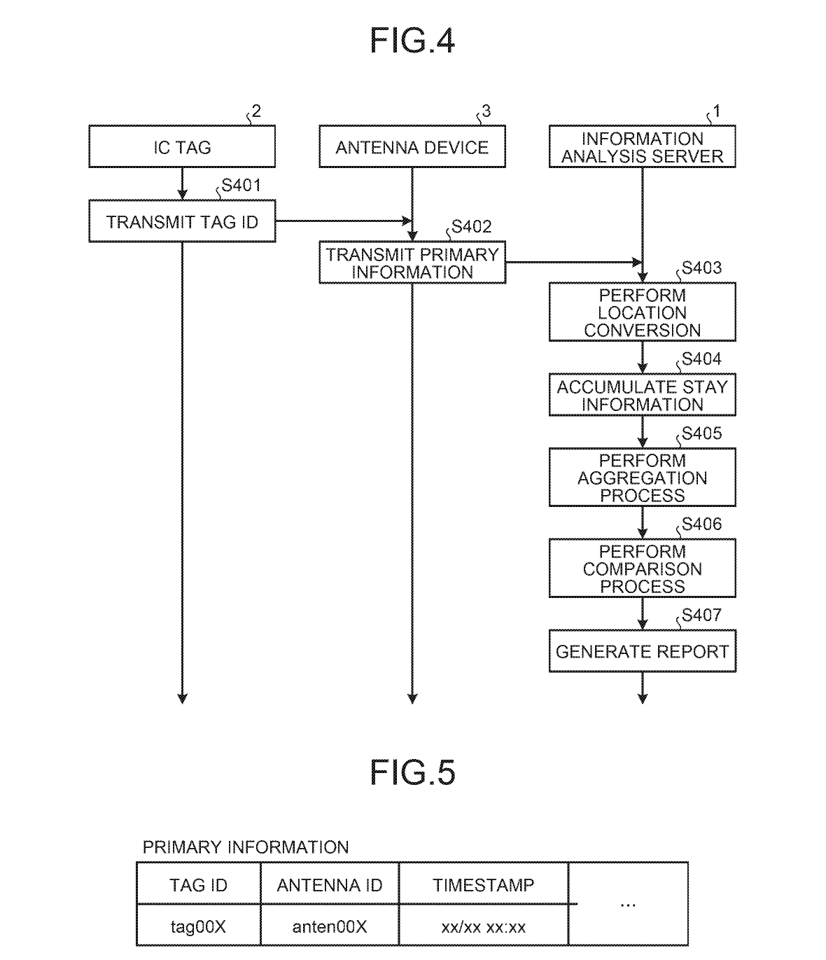

The entire operation of the personnel management system according to the embodiment will be described below by using a sequence diagram illustrated in FIG. 4. As illustrated in FIG. 4, the IC tag 2 carried by a worker emits radio waves and transmits an internally-stored tag ID (S401). The tag 2 according to the embodiment is an active IC tag that emits radio waves by itself by using power of a built-in battery. The interval of emission of radio waves by the IC tag 2 is a short second-scale interval, such as one-second interval, by which the location of the IC tag 2 can be recognized in real time.

If the IC tag 2 emits radio waves, the antenna device 3 with a detection range corresponding to a range including the position at which the IC tag 2 is located receives the radio waves and acquires the transmitted tag ID. The antenna device 3 that has received the tag ID generates primary information by associating the antenna ID for identifying the antenna device 3 itself among a plurality of the antenna devices 3, the received tag ID, and a timestamp indicating a time of receiving the radio waves, and transmits the primary information to the information analysis server 1 (S402). The information transmitted at S402 is oscillator detection information indicating that the antenna device 3 has detected the IC tag 2, and the timestamp is used as timing information.

FIG. 5 is a diagram illustrating an example of the primary information transmitted from the antenna device 3 to the information analysis server 1. The interval of transmission of the information by the antenna device 3 to the information analysis server 1 is a second-scale interval nearly equal to the interval of emission performed by the IC tag 2. The information analysis server 1 that has received the primary information converts the antenna ID included in the primary information into information on a location on the basis of a location table in which the antenna ID for identifying each of the antenna devices 3 is associated with each of the processes included in the lines in the factory illustrated in FIG. 3 (S403).

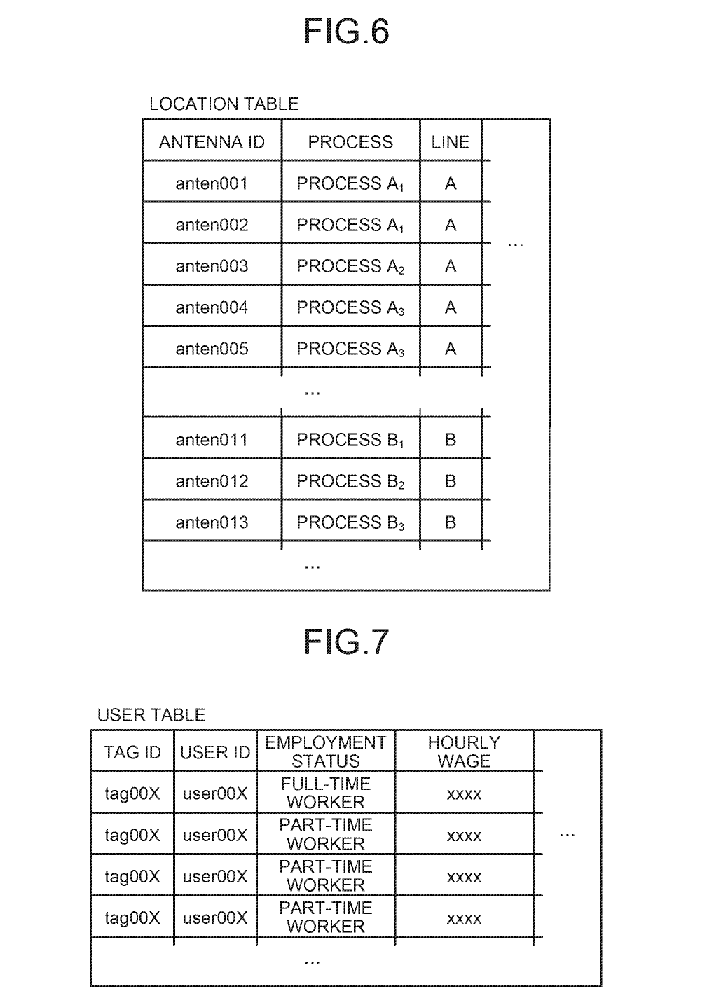

FIG. 6 is a diagram illustrating an example of the location table according to the embodiment. As illustrated in FIG. 6, in the location table according to the embodiment, an “antenna ID” is associated with both of a “line” the factory and a “process” in the line. In some cases, a plurality of “antenna IDs” may be associated with a single “process” as illustrated in FIG. 6. This indicates a case in which a workplace of a single process is covered by the reception ranges of a plurality of the antenna devices 3 in the arrangement of the antenna devices 3 illustrated in FIG.

In addition to the location table illustrated in FIG. 6, the information analysis server 1 holds a user table as illustrated in FIG. 7. As illustrated in FIG. 7, the user table according to the embodiment is information in which pieces of information on a “tag ID”, a “user ID”, an “employment status”, and an “hourly wage” are associated with one another. The “tag ID” is an identifier stored in each of the IC tags 2 as described above. The “user ID” is an identifier for identifying each worker, and is associated with an identifier of a worker who carries the corresponding IC tag 2.

The “employment status” is information indicating an attribute of each worker, such as a “full-time worker”, a “part-time worker”, or a “short-hour worker”. The “hourly wage” is a labor cost per unit time for each worker. The information analysis server 1 refers to the user table illustrated in FIG. 7 when performing an information analysis.

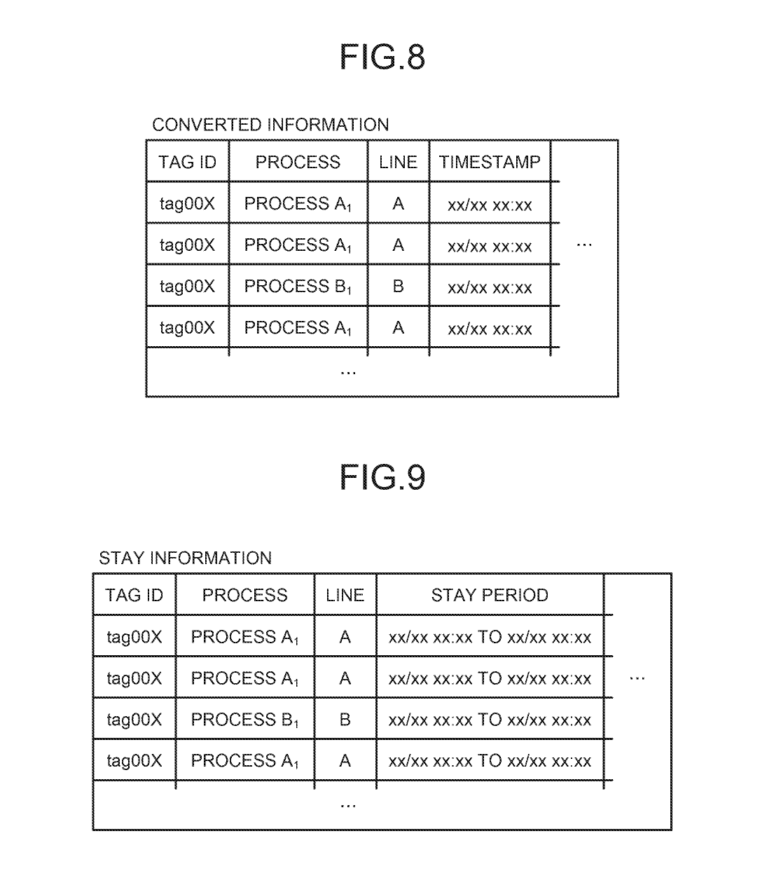

FIG. 8 is a diagram illustrating converted information obtained by converting the primary information based on the location table as illustrated in FIG. 6. As illustrated in FIG. 8, the “antenna ID” illustrated in FIG. 5 is converted into a “process” and a “line” based on the location table illustrated in FIG. Upon generating the converted information illustrated in FIG. 8 through the conversion into a location, the information analysis server 1 generates and accumulates stay information indicating a location and a stay period of a worker carrying each of the IC tags, on the basis of the converted information (S404).

FIG. 9 is a diagram illustrating an example of the stay information according to the embodiment. As illustrated in FIG. 9, in the stay information, the “tag ID”, the “process”, and the “line” are associated with one another similarly to the converted information, and information on a “stay period” indicating the period of stay in the place for the “process” is also associated. The information on the “stay period” is obtained based on a “timestamp” included in the converted information.

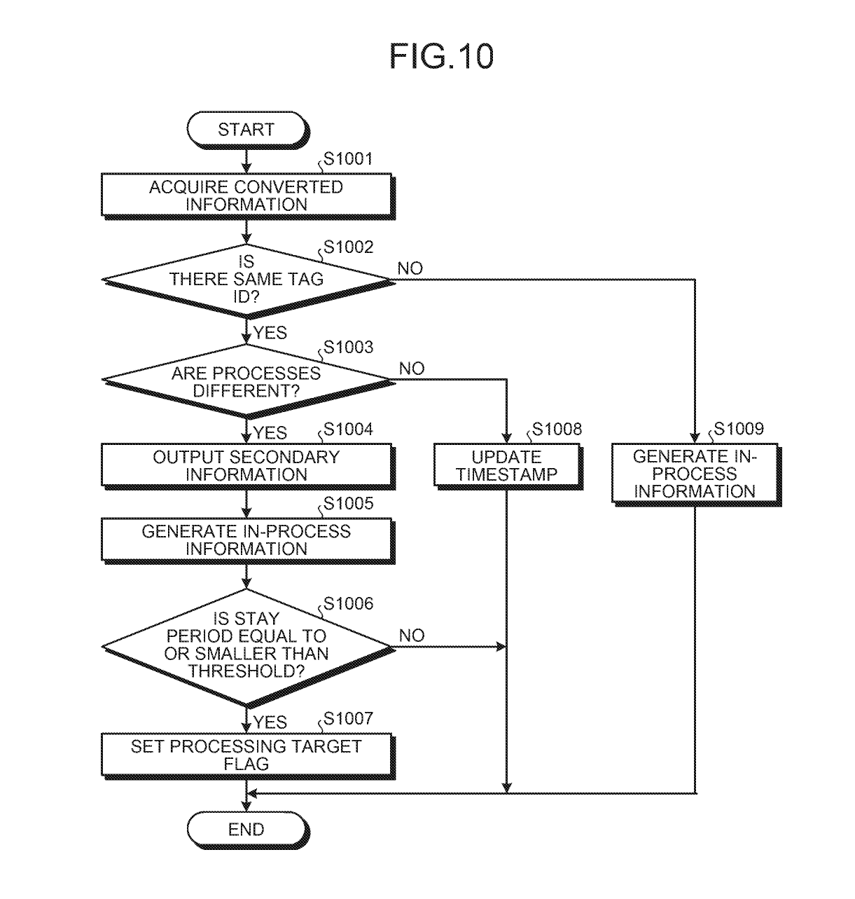

The operation performed by the information analysis server 1 to obtain the stay information based on the converted information in the embodiment will be described below. As illustrated in FIG. 10, when the information analysis server 1 acquires the converted information (S1001), the information analysis server 1 refers to the “tag ID” included in the converted information, and checks whether there is a tag ID that has already been received and processed, that is, whether the same IC tag has already been detected (S1002).

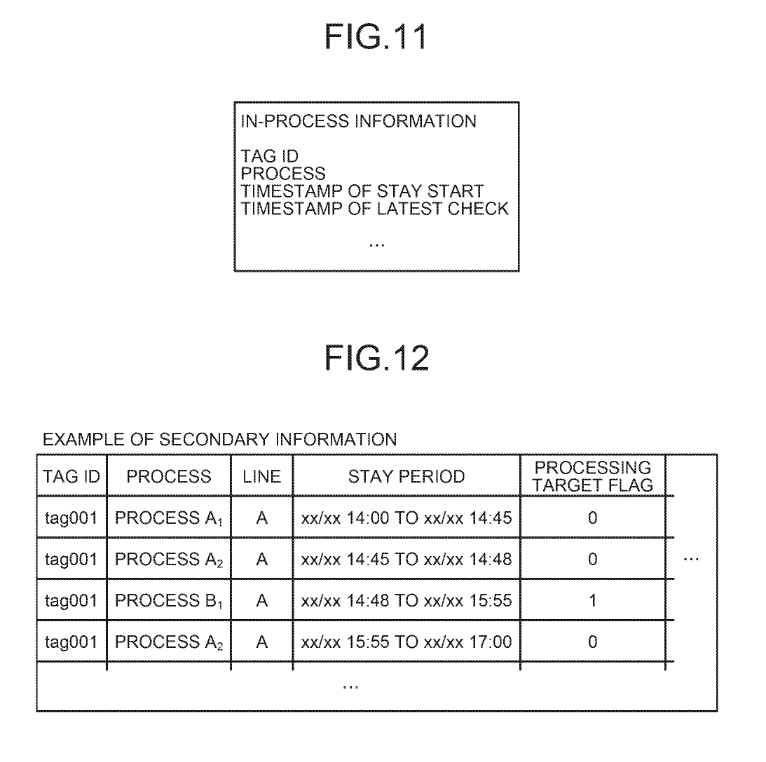

Upon receiving the primary information because of detection of the radio waves of the IC tag by each of the antenna devices 3 and upon subsequently generating the converted information, the information analysis server 1 generates in-process information as illustrated in FIG. 11 for each “tag ID”. Therefore, in the determination at S1002, the information analysis server 1 checks the presence or absence of the in-process information in which the “tag ID” included in the newly-received converted information is specified.

As a result of the determination at S1002, if there is no in-process information in which the same “tag ID” is specified (NO at S1002), the information analysis server 1 generates the in-process information as illustrated in FIG. 11 (S1009), and ends the process. In the in-process information illustrated in FIG. 11, the “tag ID” and the “process” are the same information as the information included in the converted information. The information analysis server 1 sets a “timestamp” that is received when the in-process information is newly generated in a “timestamp of stay start” illustrated in FIG. 11.

As a result of the determination at S1002, if there is the in-process information in which the same “tag ID” is specified (YES at S1002), the information analysis server 1 subsequently checks whether the “process” in the received converted information and the “process” included in the in-process information are different (S1003). If the “processes” are the same (NO at S1003), it is indicated that the worker who carries the IC tag 2 identified by the tag ID is engaged in the operation of the same process in the same place. In this case, the information analysis server 1 updates a “timestamp of latest check” illustrated in FIG. 11 with the “timestamp” included in the received converted information (S1008), and ends the process.

In contrast, if the “processes” are different (YES at S1003), it is indicated that the worker who carries the IC tag 2 identified by the tag ID has moved to a place for a different process. In this case, the information analysis server 1 generates, as secondary information, in-process information including the “tag ID” (S1004), and generates new in-process information based on the received converted information (S1005).

The secondary information generated though the process at S1004 is information which includes the same information as the stay information illustrated in FIG. 9 and in which a period from the “timestamp of stay start” the “timestamp of latest check” illustrated in FIG. 11 is set as the “stay period” illustrated in FIG. 9. Through the process at S1005, the new in-process information on the place to which the worker has moved is generated. The processes at S1005 and S1004 may be performed in random order. However, if the in-process information obtained before move is to be overwritten with the in-process information obtained after move, it is necessary to first perform the process at S1004.

Upon completion of the process at S1005, the information analysis server calculates the length of the “stay period” included in the generated secondary information, and checks whether a calculation result is equal to or smaller than a predetermined threshold (S1006). The threshold to be compared at S1006 is a threshold for determining whether the worker has actually performed the operation in the place, and is set to, for example, a few seconds to a few minutes.

As a result of the determination at S1006, if the stay period exceeds the threshold (NO at S1006), the information analysis server 1 ends the process. In contrast, if the stay period is equal to or smaller than the threshold (NO at S1006), the information analysis server sets a “processing target flag” in the generated secondary information (S1007), and ends the process. The “processing target flag” is an identifier that, when it is determined that the stay period is short and the operation has not actually been performed, indicates a need of a noise removal process in order to accurately determine a time in which each worker has performed the operation in each process.

FIG. 12 is a diagram illustrating an example of the secondary information generated through the above-described process. As illustrated in FIG. 12, the “tag ID”, the “process”, the “line”, and the “stay period” are associated with one another; therefore, it is possible to confirm from when to when which of the workers has stayed in a workplace of which of the processes. In other words, the secondary information illustrated in FIG. 12 is detection period information indicating a period in which the IC tag 2 is continuously detected by the antenna device 3. Furthermore, with the setting of the “processing target flag”, it is possible to confirm that a too short stay needs to be processed as a noise.

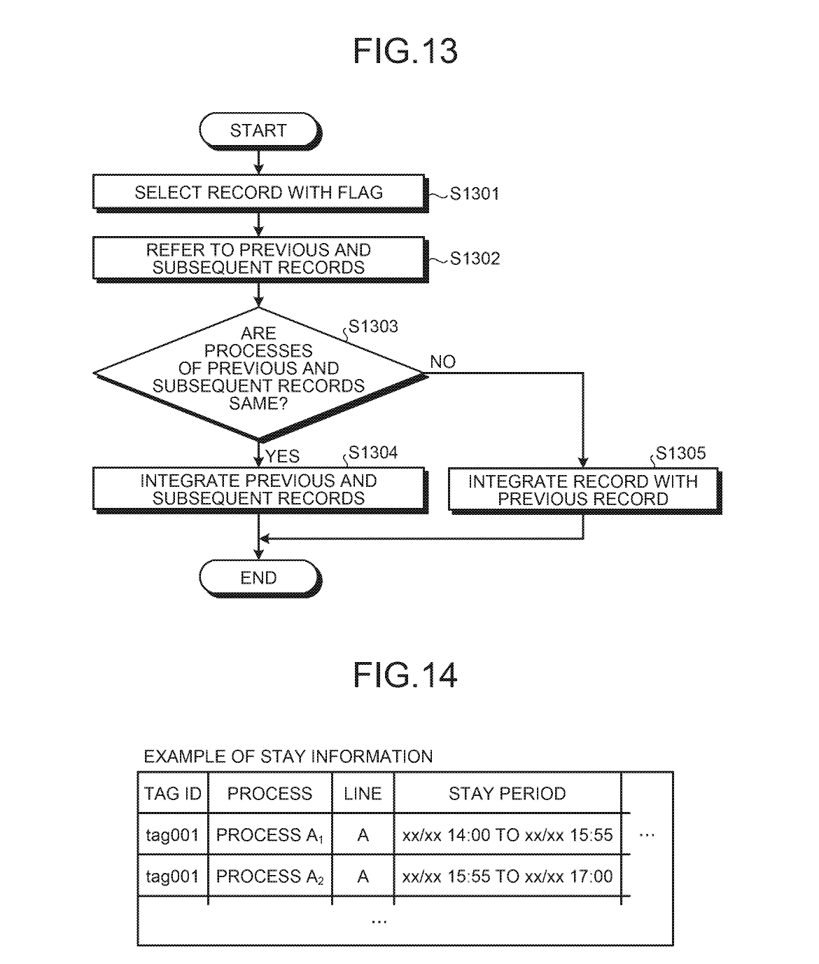

The noise removal operation based on the secondary information as illustrated in FIG. 12 will be described below with reference to FIG. 13. The operation of a flowchart illustrated in FIG. 13 is the noise removal operation. However, at S1006 in FIG. 10, determination is already performed as to whether the worker has actually performed the operation in the “process” corresponding to the workplace associated with the antenna device 3 that has detected the tag 2 in the stay period, on the basis of the length of the “stay period” included in the secondary information. Therefore, the operation after S1006 in FIG. 10 and the operation in FIG. 13 are included in the noise removal process, and a stay information generating unit 103 functions as a noise removal processing unit in the operation after S1006.

As illustrated in FIG. 13, the information analysis server 1 selects a record in which the “processing target flag” is set from the generated secondary information (S1301). Subsequently, the information analysis server 1 refers to the “stay period” of the selected record, and refers to records that include the “stay period” indicating the previous and subsequent timings and that include the same “tag ID” (S1302).

In the example in FIG. 12, a record in which the “processing target flag” is set to “1” is selected at S1301, and records above and below the selected record are referred to at S1302. The information analysis server 1 checks the “processes” of the two records referred to at S1302, and checks whether the “processes” of the two records are the same (S1303).

As a result of the determination at S1303, if the “processes” of the previous and subsequent records are the same (YES at S1303), it is determined that the record in which the processing target lag is set indicates that the worker has temporarily moved to a different place and the operation in the previous and subsequent records is continued. Therefore, the information analysis server integrates the “stay periods” of the previous and subsequent records referred to at S1302 (S1304).

FIG. 14 is a diagram illustrating an example of a result of integration in the secondary information as illustrated in FIG. 12 through the process at S1304. As illustrated in FIG. 14, the record in which the “processing target flag” is set in FIG. 12, that is, the record in which the “process” is set to the “process B1”, is information that is removed as a noise and that indicates that the operation of the process A2″ has continued during this time. That is, an operation performance of a worker associated with a “tag001” is removed from the operation performance of the “process B1”, and the worker is assumed to have continuously performed the operation of the “process A1” corresponding to the operation performances at the previous and subsequent time points.

In contrast, as a result of the determination at S1303, if the “processes” of the previous and subsequent records are different (NO at S1303), it is determined that the record in which the processing target flag is set indicates that the worker has temporarily passed through the place while moving from a certain place to a certain place. Therefore, the information analysis server 1 integrates the “stay period” of the record in which the “processing target flag” is set and the previous record between the previous and subsequent records referred to at S1302 (S1305).

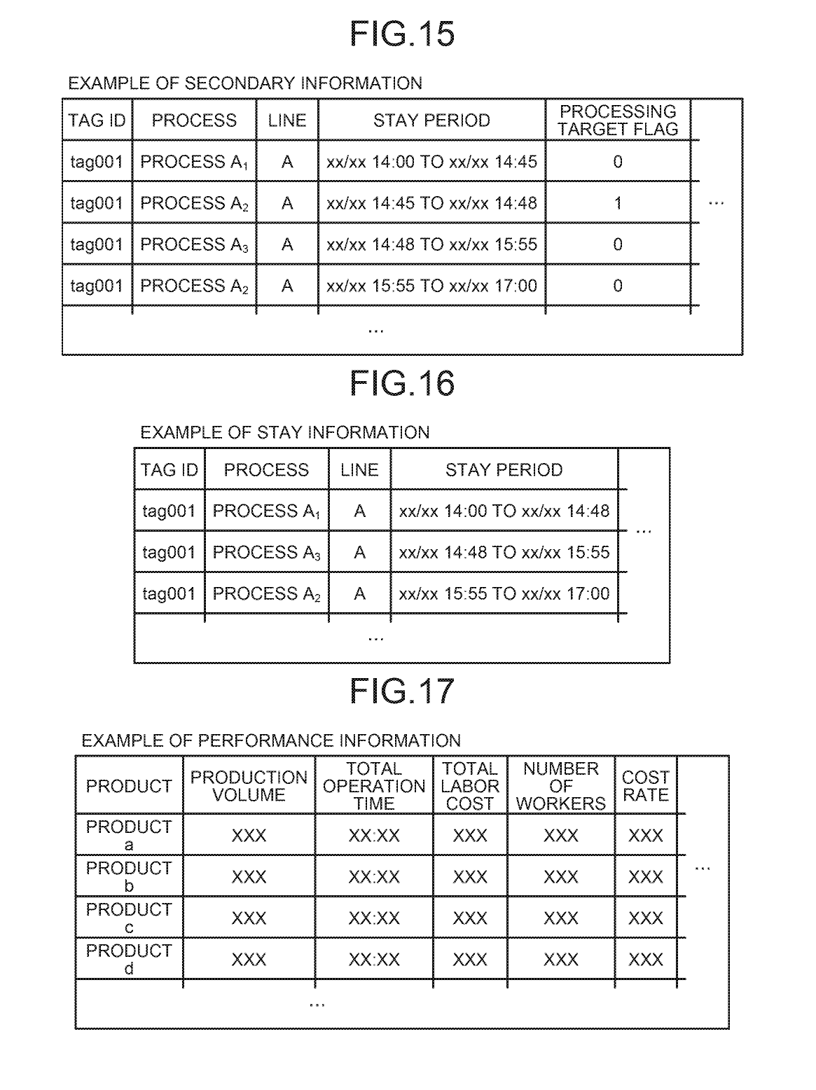

FIG. 15 is a diagram illustrating an example of the secondary information when the “processes” of the previous and subsequent records are different. FIG. 16 is a diagram illustrating an example in which the records are integrated through the process at S1305. As illustrated in FIG. 16, the record in which the “processing target flag” is set in FIG. 15, that is, the record in which the “process” is set to the “process A2”, is removed as a noise, and the “stay period” of the record is integrated with the previous record of the “process A1”.

As described above, the information analysis server according to the embodiment performs the noise removal process on information that is obtained by detecting the IC tag 2, that is, information indicating a place and the length of stay in the place for each of the IC tags 2. Therefore, it is possible to remove information that is determined as indicating presence in the result of detection of the IC tag 2 although the operation has not actually been performed, and it is possible to recognize, with high accuracy, a place in which each worker has performed the operation. The information from which a noise has been removed as illustrated in FIG. 14 and FIG. 16 is accumulated as the stay information illustrated in FIG. 9.

Referring back to FIG. 4, the information analysis server 1 that has accumulated the stay information performs an aggregation process at a predetermined timing, such as every day or every week (S405). Through the aggregation process at S405, performance information as illustrated in FIG. 17 is generated. As illustrated in FIG. 17, the performance information according to the embodiment is information in which a “product”, a “production volume”, a “total operation time”, a “total labor cost”, the “number of workers”, and a “cost rate” are associated.

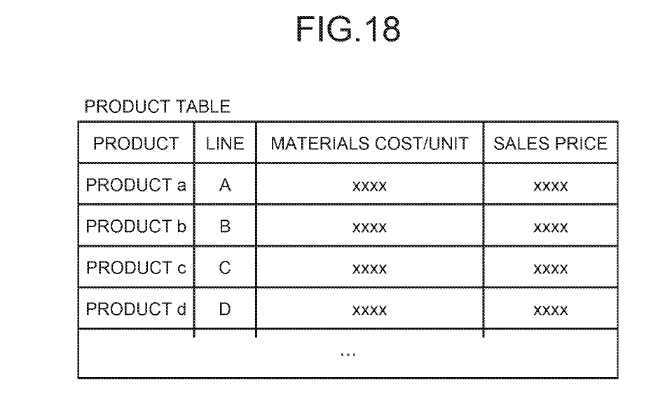

The “product” is information indicating a product manufactured in the factory. The information analysis server 1 acquires a product table as illustrated in FIG. 18, and recognizes which “product” is generated in each “line”. In the product table, information on a “materials cost/unit”, which indicates the materials cost per unit for generating each product, and a “sales price”, which is a sales price of a unit of each product, are associated.

The “materials cost/unit” and the “sales price” illustrated in FIG. 18 may be changed. Therefore, the operator operates the operator terminal 4 to continuously generate the latest product table and store the latest product table in the information analysis server 1.

The “production volume” is information indicating the number of units of each product manufactured in a period in which the stay information is aggregated, and is transmitted to the information analysis server 1 by the operator through operation of the operator terminal 4. The “total operation time” is a total time of operations performed by workers in the production line of each product. The information analysis server 1 calculates the “total operation time” by aggregating the lengths of the “stay periods” of each “line” based on the stay information illustrated in FIG. 9.

The “total labor cost” is a total labor cost of workers who have performed operations in the production line of each product. The information analysis server 1 first aggregates the lengths of the “stay periods” associated with each “line” for each “tag ID” on the basis of the stay information illustrated in FIG. 9, and then multiplies the aggregated length by the “hourly wage” included in the user table illustrated in FIG. Consequently, the labor cost of each worker due operation performed in each “line” is calculated. The information analysis server 1 calculates the “total labor cost” illustrated in FIG. 17 by aggregating the labor costs calculated as above for each “line”.

The “number of workers” is a total number of workers who have performed operations in the production line of each product. The information analysis server counts the “tag IDs” associated with each “line” based on the stay information illustrated in FIG. 9. At this time, the same “tag ID” is counted only once. Consequently, the total number of the workers who have performed the operations in each “line” is calculated.

The “cost rate” is a cost rate in which a materials cost and a labor cost are taken into account for each product. The information analysis server 1 calculates the materials cost of each product by multiplying the “production volume” illustrated in FIG. 17 by the “materials cost/unit” illustrated in FIG. 18. Furthermore, the information analysis server 1 calculates the sales price of each product by multiplying the “production volume” illustrated in FIG. 17 by the “sales price” illustrated in FIG. 18. Then, the information analysis server 1 calculates the cost rate of each product based on Expression (1) below.

$$[ COST RATE ] = \frac{[ TOTAL LABOR COST ] + [ MATERIALS COST ]}{[ SALES PRICE ]} \qquad ( 1 )$$

As described above, a noise is removed through the noise removal operation from the “stay period” in the stay information illustrated in FIG. 9. Therefore, the “total operation time” calculated based on this information is information highly accurately indicating the process performed by the workers. In addition, the information on the “total labor cost” obtained from the above-described “total operation time” is highly accurate.

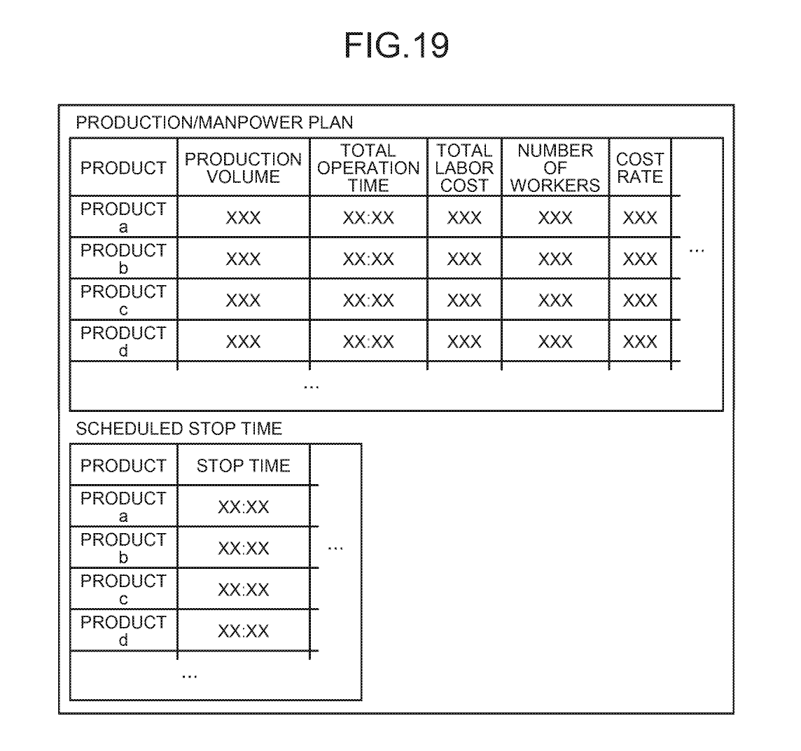

Upon generating the performance information as illustrated in FIG. 17 through the above-described process, the information analysis server 1 compares plan information input by the operator with the performance information (S406), and generates a report based on a comparison result (S407). FIG. 19 is a diagram illustrating the plan information according to the embodiment. As illustrated in FIG. 19, the plan information according to the embodiment includes information on “production/personnel plan” including items corresponding to the items of the performance information illustrated in FIG. 17. Furthermore, the plan information includes information on “scheduled stop time” associated with a scheduled “stop time” for stopping operations to supply materials or set devices for each production line for manufacturing each product.

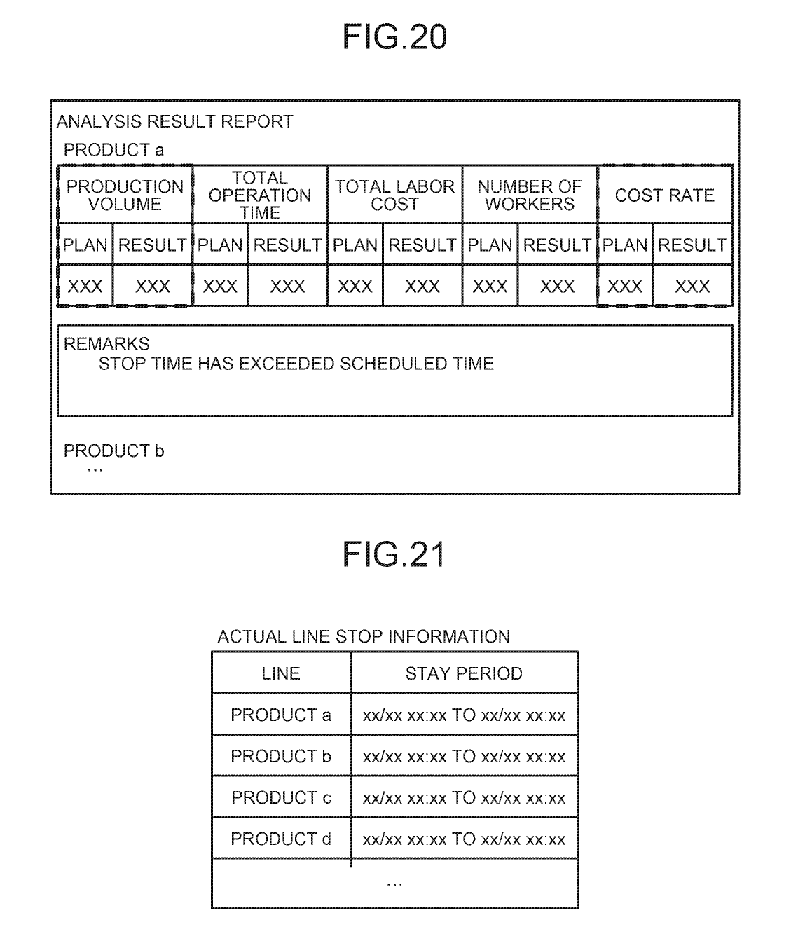

FIG. 20 is a diagram illustrating an example report generated through the process at S407. The information illustrated in FIG. 20 is transmitted from the information analysis server 1 to the operator terminal 4, and is displayed on the operator terminal 4. As illustrated in FIG. 20, in the report, a “plan” and a “result” are described for each of the items such as the “production volume”, the “total operation time”, the “total labor cost”, the “number of workers”, and the “cost rate” for each of the products, such as a “product a” and a “product b”. Each piece of the information is extracted from the performance information illustrated in FIG. 17 and the production/personnel plan illustrated in FIG. 10.

The information analysis server 1 generates information for notifying the operator of a difference between the “result” and the “plan” of each item. Specifically, if the “result” does not meet the “plan”, for example, if the “result” is smaller than the “plan” in the “production volume” or if the “result” exceeds the “plan” in the “cost rate”, the information analysis server 1 generates report information in which the item is displayed with emphasis. In the example in FIG. 20, as in the example described above, the “result” is smaller than the “plan” in the “production volume” and the “result” exceeds the “plan” in the “cost rate”.

Furthermore, if there is an item that needs displayed with emphasis as illustrated in FIG. 20, the information analysis server 1 generates information describing matters that may be regarded as a cause in a “remarks” column. In the example in FIG. 20, it is described that the stop time of the production line has exceeded the scheduled stop time. To generate the above-described information, the information analysis server 1 acquires actual line stop information indicating actual stop of the production line in the factory on the basis of input by the operator.

FIG. 21 is a diagram illustrating the actual line stop information according to the embodiment. As illustrated in FIG. 21, in the actual line stop information according to the embodiment, a “line” and a “stop period” are associated. The information analysis server 1 compares the stop time of each product based on the “scheduled stop time” illustrated in FIG. 19 and the actual line stop information illustrated in FIG. 21. If the “stop period” described in the actual line stop information exceeds the “stop period” described in the “scheduled stop time”, the information analysis server 1 generates information to describe remarks as illustrated in FIG. 20.

The actual line stop information illustrated in FIG. 21 is input in the information analysis server 1 by the operator through operation of the operator terminal 4 as described above. Alternatively, it may be possible to automatically acquire the actual line stop information illustrated in FIG. 21 from a control system that controls the production lines in the factory.

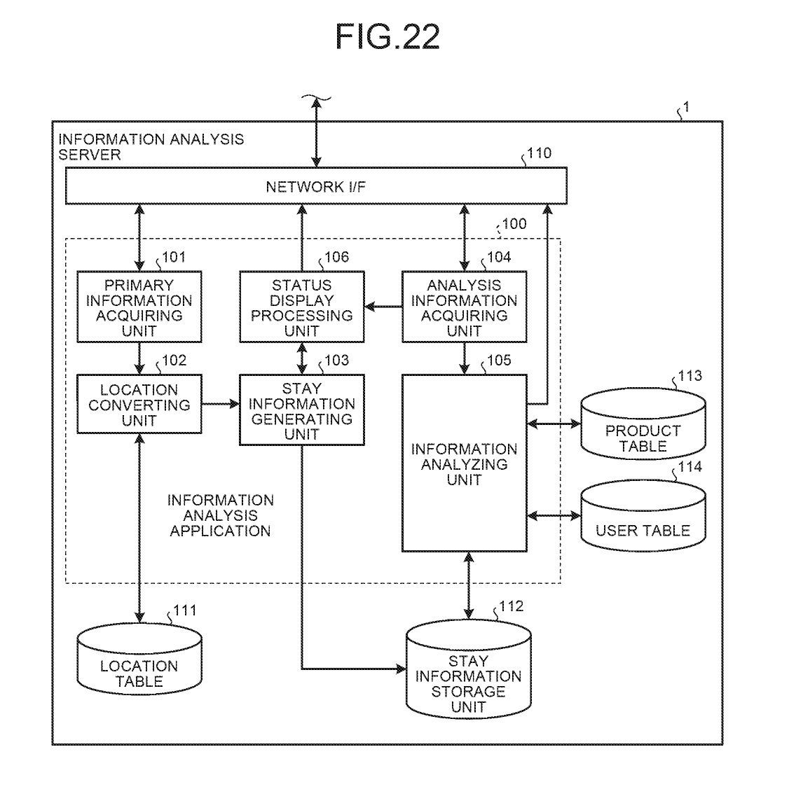

FIG. 22 is a block diagram illustrating a functional configuration of the information analysis server 1 that implements the above-described functions. As illustrated in FIG. 22, the information analysis server 1 according to the embodiment includes an information analysis application 100, a network I/F 110, a location table 111, a stay information storage unit 112, a product table 113, and a user table 114. The network. I/F 110 is an interface that enables the information analysis server 1 to communicate with other devices via a network, and, for example, an Ethernet (registered trademark) interface is used.

The information analysis application 100 is a software application that provides the functions of the information analysis server 1 as described above, and is constructed by causing the CPU 10 illustrated in FIG. 2 is perform arithmetic operation in accordance with a corresponding program. The program for constructing the information analysis application 100 is the personnel management program.

The location table 111 is a storage unit that stores therein information included in the location table illustrated in FIG. 6. The stay information storage unit 112 is a storage unit that stores therein the stay information illustrated in FIG. 9. The product table 113 is a storage unit that stores therein the product table illustrated in FIG. 18. The user table 114 is a storage unit that stores therein the user table illustrated in FIG. 7. The location table 111, the stay information storage unit 112, the product table 113, and the user table 114 are implemented by the HDD 40 illustrated in FIG. 2.

The information analysis application 100 includes a primary information acquiring unit 101, a location converting unit 102, the stay information generating unit 103, an analysis information acquiring unit 104, an information analyzing unit 105, and a status display processing unit 106. The primary information acquiring unit 101 acquires the primary information illustrated in FIG. 5 from each of the antenna devices 3 in accordance with the process at S402 in FIG. 4, and inputs the primary information in the location converting unit 102. Specifically, the primary information acquiring unit 101 functions as a detection period information acquiring unit.

The location converting unit 102 performs the location conversion process at S403 in FIG. 4, and generates the converted information illustrated in FIG. 8. Therefore, the location converting unit 102 refers to the location table 111 and converts the “antenna ID” included in the primary information illustrated in FIG. 5. The stay information generating unit 103 acquires the converted information from the location converting unit 102, performs the operation of generating the secondary information illustrated in FIG. 10, performs the noise removal operation illustrated in FIG. 13, and generates the stay information. The stay information generating unit 103 stores the generated stay information in the stay information storage unit 112.

The analysis information acquiring unit 104 acquires analysis information as information necessary for the aggregation process to generate the performance information as illustrated in FIG. 17 or for the process of generating the report information as illustrated in FIG. 20, accordance with operation performed by the operator. The analysis information includes, for example, information on a production volume in the aggregation period for each product, that is, the “production volume” illustrated in FIG. 17, the plan information illustrated in FIG. 19, and the actual line stop information illustrated in FIG. 21.

The information analyzing unit 105 generates the performance information as illustrated in FIG. 17 and the report information as illustrated in FIG. 20, on the basis of the information stored in the stay information storage unit 112, the product table 113, and the user table 114 or the information acquired by the analysis information acquiring unit 104.

The status display processing unit 106 generates display information for displaying a stay status of workers in a workplace in real time on the basis of the information that is transmitted from each of the antenna devices 3 to the information analysis server 1, and transmits the display information to the operator terminal 4. The status display processing unit 106 according to the embodiment acquires the in-process information illustrated in FIG. 11 from the stay information generating unit 103 and generates the display information for displaying the stay status of the workers in the workplace.

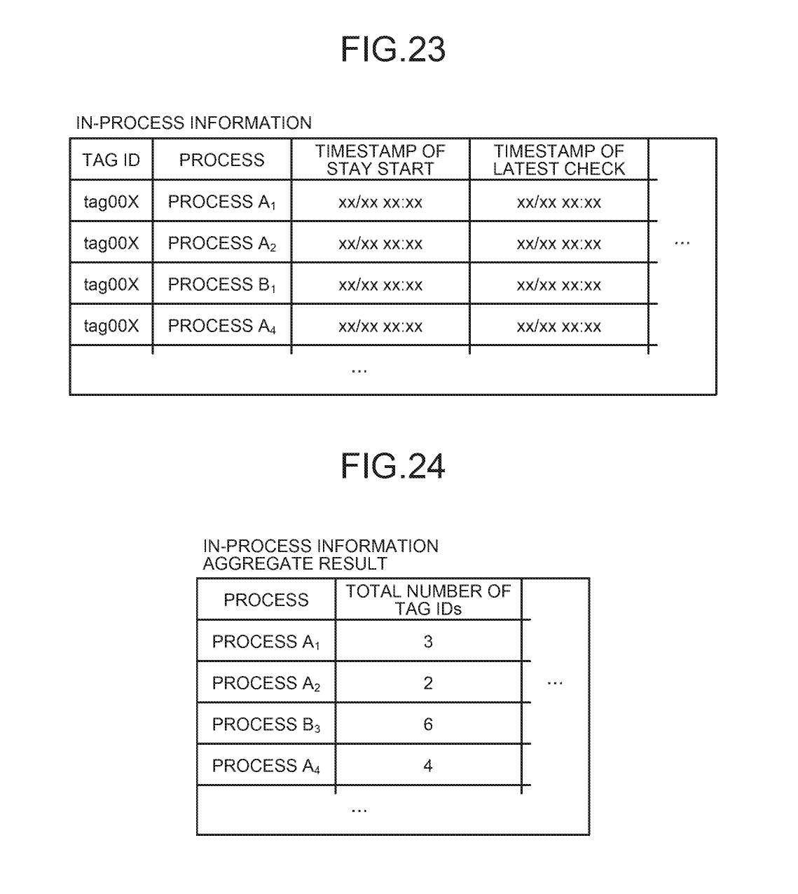

As described above, the in-process information is updated for each tag ID. Therefore, the status display processing unit 106 acquires a table as illustrated in FIG. 23 by acquiring the in-process information from the stay information generating unit. FIG. 23 is a diagram illustrating the in-process information for each tag ID. The status display processing unit 106 counts the number of records, that is, the number of the “tag IDs”, for each “process” in the information illustrated in FIG. 23, and generates information on an in-process information aggregate result as illustrated in FIG. 24.

The in-process information aggregate result illustrated in FIG. 24 is information in which each “process” is associated with a “total number of tag IDs” that is obtained by counting the number of IC tags detected by the antenna device 3 corresponding to the process. Specifically, in the example in FIG. 24, it is indicated that three workers have stayed in the range of the workplace for the “process A1”.

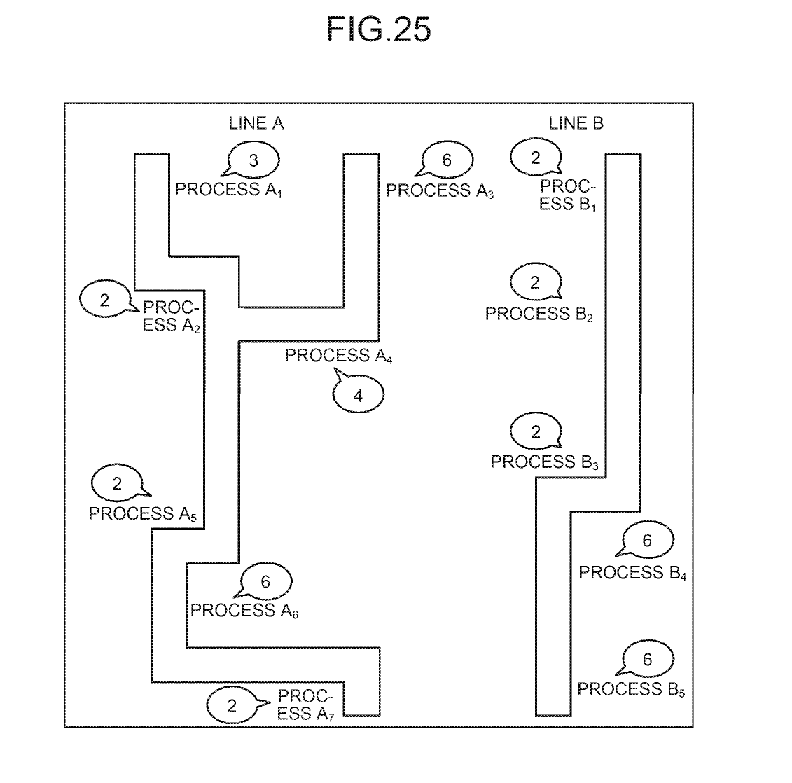

Upon generating the in-process information aggregate result illustrated in FIG. 24, the status display processing unit 106 generates display information on a status display screen in which a corresponding “total number of tag IDs” is displayed in the place for each process in the floor plan of the factory as illustrated in FIG. 3. FIG. 25 is a diagram illustrating an example of the status display screen according to the embodiment. As illustrated in FIG. 25, in the status display screen according to the embodiment, the “total number of tag IDs” as illustrated in FIG. 24 is displayed in association with a place corresponding to each process in the floor plan of the factory as illustrated in FIG. 3.

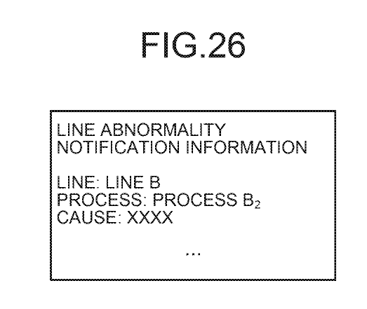

Furthermore, the status display processing unit 106 according to the embodiment generates a status display screen in which an abnormal state of a production line is displayed on the basis of information indicating an abnormality of the production line that has occurred in the factory. FIG. 26 is a diagram illustrating an example of line abnormality notification information that the analysis information acquiring unit 104 acquires in the information analysis server 1 when an abnormality occurs in the product on line.

As illustrated in FIG. 26, in the line abnormality notification information, a “line” in which an abnormality has occurred, a “process” corresponding to a portion where the abnormality has occurred, and a “cause” of the abnormality are specified. The line abnormality notification information illustrated in FIG. 26 is transmitted to the information analysis server 1 by the operator through operation of the operator terminal 4, or the information analysis server 1 may automatically acquire the line abnormality notification information from a control system that controls the production line.

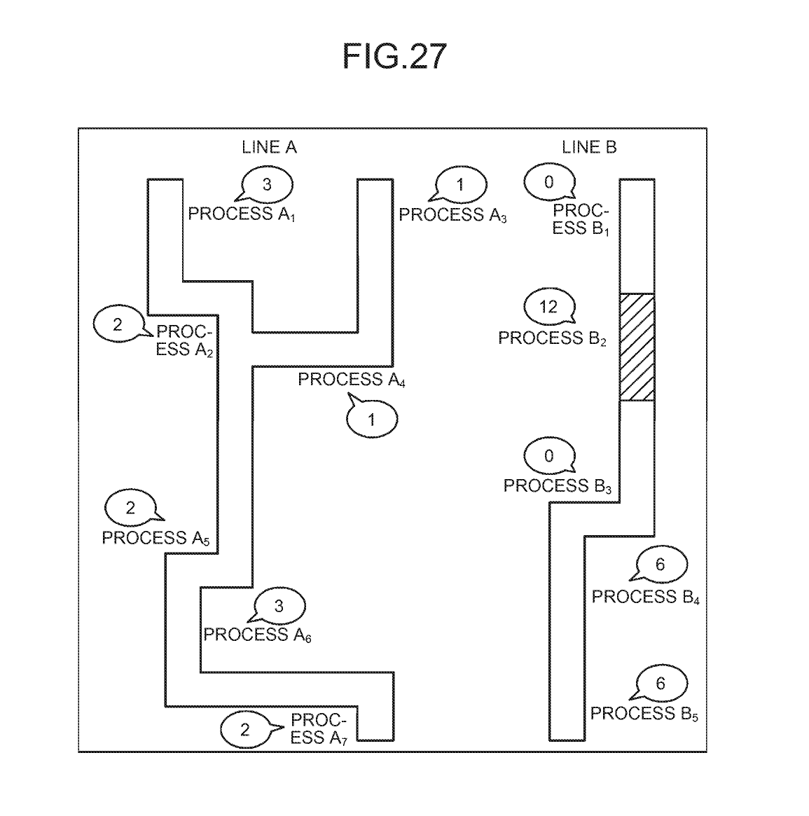

FIG. 27 is a diagram illustrating an example of the status display screen in which the abnormal state is displayed based on the line abnormality notification information illustrated in FIG. 26. As illustrated in FIG. 27, the status display processing unit 106 generates display information such that a portion corresponding to the “line” and the “process” specified in the line abnormality notification information is displayed with emphasis. The position of the portion to be displayed with emphasis based on the “line” and the “process” specified in the line abnormality notification information is specified by the coordinates or the like on the image in advance.

According to the screen display illustrated in FIG. 27, even when workers have temporarily gathered in a certain place due to occurrence of an abnormality and the number of the workers displayed in association with each process has increased, the operator can recognize that this situation has occurred due to the abnormality of the production line. With the display screen as described above, it is possible to improve the convenience of the operator to perform not only management of the performance of the production line as described above but also management of the factory in real time.

As described above, in the personnel management system according to the embodiment, with the function to remove a noise as described above with reference to FIG. 13, it possible to improve the accuracy of a detection result in the system that detects a location of a worker through wireless communication.

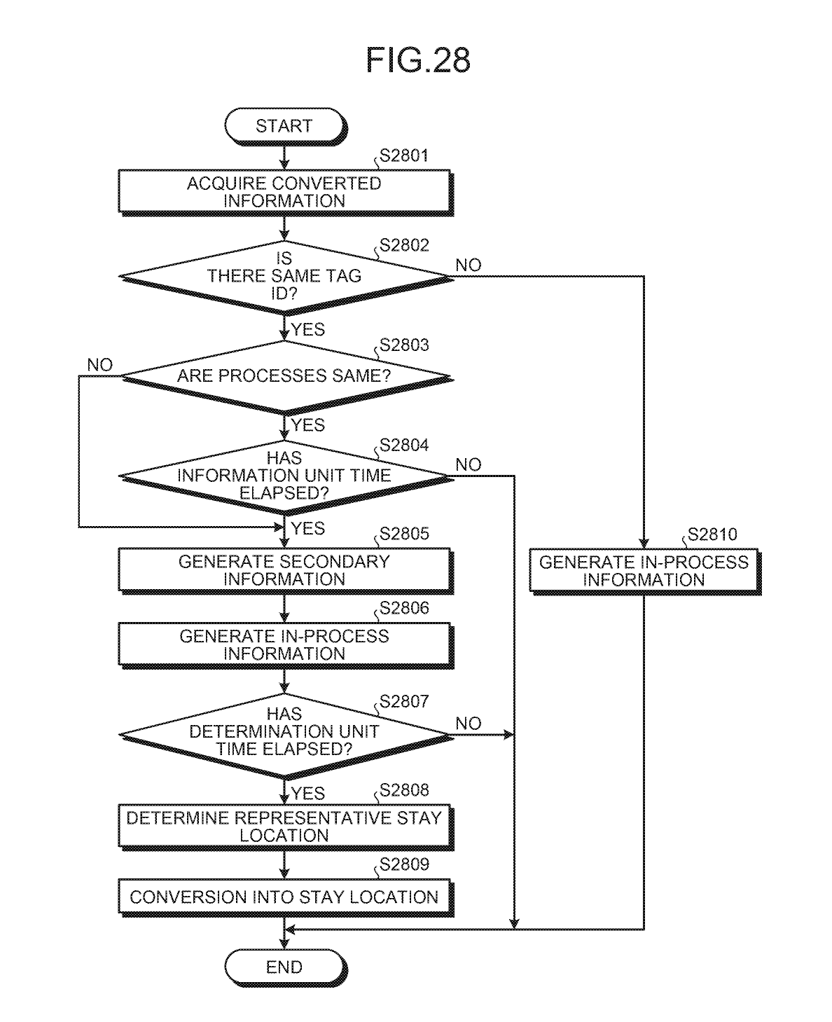

In the above-described embodiment, an example has been described in which, as illustrated in FIG. 10 and FIG. 13, the secondary information is generated for each continuous stay period of each “process”, and a record with a stay period equal to or smaller than the threshold is integrated based on the previous and subsequent “processes”. However, this is one example, and the way to remove a noise is not limited to this example. It is possible to obtain the same effects by a configuration that converts the secondary information after determining that an operation has not been actually performed based on the stay period. With reference to FIG. 28, another embodiment to generate the secondary information and to perform the noise removal operation will be described.

In the operation in FIG. 28, the in-process information as illustrated in FIG. 11 is generated similarly to the above. At S2801, S2802, and S2810, the same processes as those at S1001, S1002, and S1009 in FIG. 10 are performed. As a result of the determination at S2802, if there is the in-process information in which the same “tag ID” is specified (YES at S2802), the information analysis server 1 subsequently checks whether the “process” in the received converted information and the “process” in the in-process information are the same (S2803).

As a result of the determination at S2803, if the processes are the same (YES at S2803), the information analysis server 1 determines whether an information unit time, which is a unit time to generate one record of the secondary information, has elapsed (S2804). The information unit time is, for example, 10 minutes. That is, in the example in FIG. 28, even if the converted information includes the same “process” and the same “line”, a record of the secondary information is generated every 10 minutes.

As a result of the determination at S2804, if the information unit time has not elapsed (NO at S2804), the information analysis server 1 ends the process. In contrast, if the information unit time has elapsed. (YES at S2804), the information analysis server 1 generates in-process information including the “tag ID” included in the converted information acquired at S2801 as a new record of the secondary information (S2805). Furthermore, the information analysis server 1 generates new in-process information based on the received converted information (S2806). If the “processes” are different at S2803, the process proceeds to S2805.

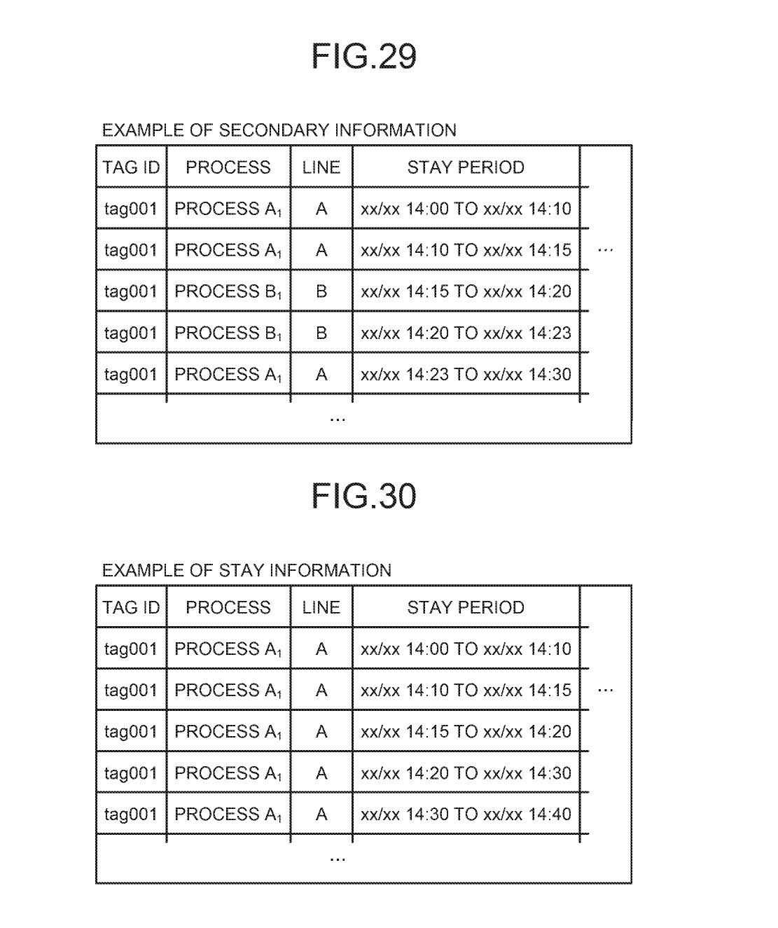

Through the processes until S2806, if the “process” has changed, the secondary information separated at the timing of change is generated, and even if the “process” has not changed, a record of the secondary information generated every information unit time. FIG. 29 is a diagram illustrating an example of the secondary information generated as described above. In FIG. 29, records are basically generated every 10 minutes, but at a portion where the process has changed from the “process A1” to the “process B1”, records are generated at the timing of change.

Upon generating the records of the secondary information as illustrated in FIG. 29, the information analysis server 1 determines whether a determination unit time, which is a unit to determine movement of a worker, has elapsed (S2807). The determination unit time is, for example, 30 minutes. That is, in the example in FIG. 28, a stay location of the worker is determined every 30 minutes.

As a result of the determination at S2804, if the determination unit time has not elapsed (NO at S2807), the information analysis server 1 ends the process. In contrast, if the determination unit time has elapsed (YES S2807), the information analysis server 1 determines representative process in a stay location (hereinafter, referred to as a “representative stay location”) of the worker at the determination unit time, on the basis of the records of the secondary information included in the determination unit time (S2808).

In FIG. 29, records from “14: 00” to “14: 30” are illustrated, and the records illustrated in FIG. 29 are subjected to the determination at S2808 as the records included in the determination unit time. At S2808, if a plurality of “processes” are included in the records in the determination unit time, the information analysis server 1 determines a “process” with the longest stay period as the representative stay location. Therefore, in the example in FIG. 29, the “process A1” in the “line A” are determined as the representative stay location.

In the noise removal process in FIG. 28 as described above, it is assumed that the operation has been performed in the process with the longest detected period in a detection result in the determination unit time. Even in this case, whether the operation has been actually performed is also determined on the basis of the length of the “stay period” included in the secondary information.

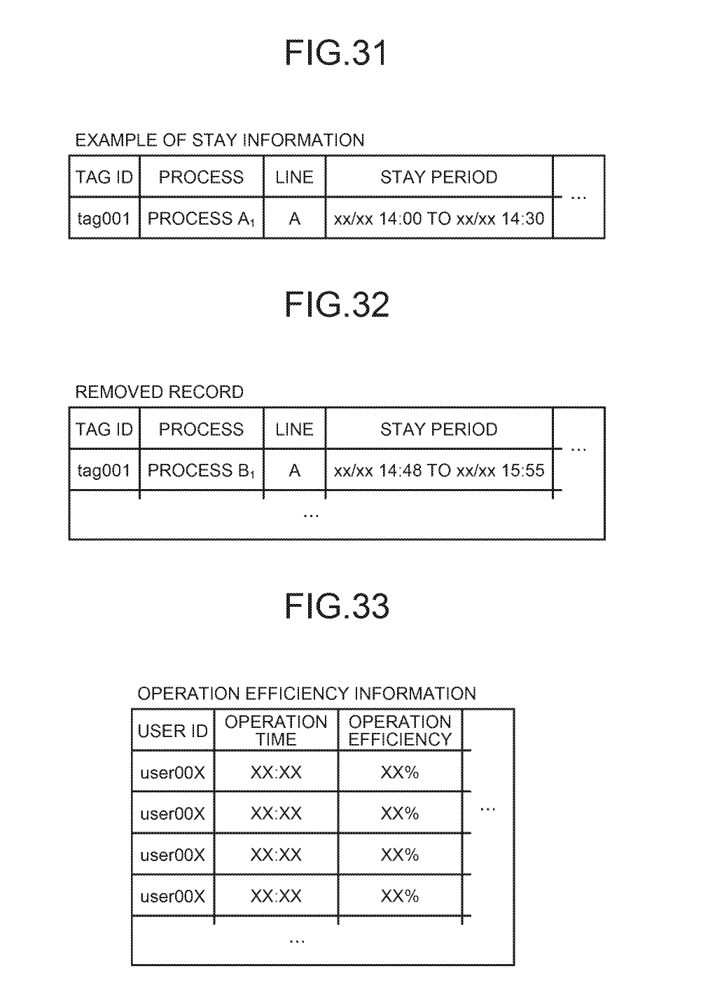

The information analysis server 1 that has determined the representative stay location converts the “processes” and the “lines” different from the representative stay location into the representative stay location (S2809), and ends the process. Consequently, the secondary information illustrated in FIG. 29 is converted as illustrated in FIG. 30. In addition, as illustrated in FIG. 31, it may be possible to perform a conversion to a record in which the determination unit time is set as the “stay period”.

As described above, as long as the antenna device 3 determines a process in which a worker has actually performed an operation on the basis of the stay period that is obtained by aggregating pieces of information generated upon reception of the tag ID from the IC tag 2, it is possible to achieve the object of the present invention.

In the above-described embodiment, for example, a record of the “process B1” illustrated in FIG. 12 is integrated with a record of the “process A1”, so that it is possible to obtain information accurately indicating that the worker has continuously performed the operation of the “process A1” without performing the operation of the “process B1”. However, it is the fact that the worker been in a place corresponding to the “process B1” in the “stay period” corresponding to the record of the “process B1”, and it is expected that the worker probably have not performed the operation of the “process B1”, nor the “process A1”.

That is, the record removed by the noise removal operation as described above is a record indicating a period in which an operation is not actually performed. It may be possible to indicate the operation efficiency of each worker based on this record. Therefore, when integrating a record in which the “processing target flag” is set with a different record in the operation in FIG. 13, the stay information generating unit 103 extracts the integrated record and stores the extracted record as a removed record in the stay information storage unit 112 as illustrated in FIG. 32.

Then, the information analyzing unit 105 aggregates the associated “stay periods” for each tag ID to thereby calculate an “individual total operation time” as a total operation time of each user. Furthermore, an actual working time is calculated by subtracting a total value of the “stay period” of the removed record illustrated in FIG. 32. By obtaining a rate of the “actual working time” to the “individual total operation time” calculated as above, it is possible to obtain an “operation efficiency”.

Upon obtaining the “operation efficiency” for each tag ID as described above, the information analyzing unit 105 generates operation efficiency information as illustrated in FIG. 33. Consequently, the operator can recognize the operation efficiency of each user.

In the above-described embodiment, an example has been described in which the antenna device 3 includes only the function to associate the antenna ID of the antenna device 3 and the timestamp with the tag ID received form the IC tag 2, and to transmit them to the information analysis server 1. Alternatively, for example, the antenna device 3 may include the function of the location converting unit 102 illustrated in FIG. 22. Furthermore, the antenna device 3 may include the function to generate the secondary information, that is, the function to perform the process illustrated in FIG. 10 among the functions of the stay information generating unit 103.

In contrast, among the functions of the stay information generating unit 103, the function of the noise removal operation needs to use information obtained from a plurality of the antenna devices 3 because it is necessary to refer to records of the secondary information associated with different “processes”. Therefore, the function to perform the noise removal operation based on the secondary information is implemented by the information analysis server 1.

According to an embodiment of the present invention, it is possible to improve the accuracy of a detection result in a system that detects a location of a worker through wireless communication.

The present invention can be implemented in any convenient form, for example using dedicated hardware, or a mixture of dedicated hardware and software. The present invention may be implemented as computer software implemented by one or more network processing apparatus. The network can comprise any conventional terrestrial or wireless communications network, such as the Internet. The processing apparatus can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implemental on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAN), and a hard disk drive (HDD). The CPU may be implemented by any desired kind of any desired number of processor. The RAM may be implemented by any desired kind of volatile or non-volatile memory. The HDD may be implemented by any desired kind of nonvolatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A personnel management system comprising:
a radio wave oscillator having a function to output an oscillator identifier for identifying the radio wave oscillator by a radio wave, the radio wave oscillator being carried by a worker;
a plurality of receivers, each having a function to detect the oscillator by acquiring the oscillator identifier by receiving the radio wave and to generate oscillator detection information by associating the oscillator identifier with a receiver identifier for identifying the receiver and timing information indicating a timing of receiving the radio wave, the plurality of receivers being arranged in a plurality of places in a workplace where the worker performs an operation; and
an information analysis device configured to manage an operation performance of the worker in the workplace on the basis of detection period information that is obtained based on the oscillator detection information and that indicates a period in which the oscillator is continuously detected by the receiver, wherein
the information analysis device includes
a noise removal processing unit configured to determine whether the worker carrying the oscillator detected in the period has actually performed an operation in a workplace associated with the receiver that has detected the oscillator in the period, on the basis of a length of the period included in the detection period information, and remove, when determining that the worker has not actually performed the operation, the worker from an operation performance in the workplace; and
an information analyzing unit configured to analyze the detection period information subjected to the noise removal process, and manage an operation performance of the worker.

2. The personnel management system according to claim 1, wherein the noise removal processing unit, when determining that the worker has not actually performed the operation, assumes that the worker has performed an operation in a workplace associated with a receiver that has detected the oscillator in a period indicating a previous timing or a subsequent timing, during the period included in the detection period information.

3. The personnel management system according to claim wherein the noise removal processing unit, when determining that the worker has not actually performed the operation and if the same receiver has detected the oscillator the periods indicating the previous timing and the subsequent timing, assumes that the worker has continuously performed the operation in the workplace associated with the receiver that has detected the oscillator during the periods indicating the previous timing and the subsequent timing.

4. The personnel management system according to claim 2, wherein the noise removal processing unit, when determining that the worker has not actually performed the operation and if different receivers have detected the oscillator in the periods indicating the previous timing and the subsequent timing, assumes that the worker carrying the oscillator has moved from a workplace associated with the receiver that has detected the oscillator in the period indicating the previous timing to a workplace associated with the receiver that has detected the oscillator in the period indicating the subsequent timing.

5. The personnel management system according to claim 1, wherein the noise removal processing unit determines whether the worker has actually performed the operation in the workplace associated with the receiver that has detected the oscillator in the period, on the basis of a result of comparison between a length of the period included in the detection period and a threshold indicating a period for determining whether the worker has actually performed the operation in the workplace.

6. The personnel management system according to claim 1, wherein
the noise removal processing unit
acquires the detection period information in which the period is separated by a predetermined information unit time,
refers to the detection period information every determination unit time that is a time including a plurality of information unit times, and
removes the worker from an operation performance in a workplace associated with a different receiver by assuming that the worker carrying the oscillator has performed an operation in a workplace associated with a receiver with a longest period among receivers that have detected the oscillator in the determination unit time.

7. The personnel management system according to claim 1, wherein the noise removal processing unit
calculates an operation time for each worker in a predetermined period based on the detection period information, and
calculates and outputs an operation efficiency with respect to the operation time for each worker based on information on the period included in the detection period information subjected to determination of determining at the worker has not actually performed the operation.

8. The personnel management system according to claim 1, wherein the information analyzing unit analyzes the detection period information subjected to the noise removal process for a predetermined period, acquires information indicating a plan of an operation of the worker in the predetermined period, and outputs notification information on a difference between an operation performance of the worker and the plan.

9. An information analysis device that operates in a personnel management system, the personnel management system including a radio wave oscillator having a function to output an oscillator identifier for identifying the radio wave oscillator by a radio wave and being carried by a worker, and a plurality of receivers, each having a function to detect the oscillator by acquiring the oscillator identifier by receiving the radio wave and to generate oscillator detection information by associating the oscillator identifier with a receiver identifier for identifying the receiver and timing information indicating a timing of receiving the radio wave, the plurality receivers being arranged in a plurality of places in a workplace where the worker performs an operation, the personnel management system being configured to manage an operation performance of the worker in the workplace, wherein
the information analysis device comprises:
a detection period information acquiring unit configured to acquire detection period information, which is obtained based on the oscillator detection information and which indicates a period in which the oscillator is continuously detected by the receiver;
a noise removal processing unit configured to determine whether the worker carrying the oscillator detected in the period has actually performed an operation in a workplace associated with the receiver that has detected the oscillator in the period, on the basis of a length of the period included in the detection period information, and removes, when determining that the worker has not actually performed the operation, the worker from an operation performance in the workplace; and
an information analyzing unit configured to analyze the detection period information subjected to the noise removal process, and manage an operation performance of the worker.

10. A personnel management method comprising:
detecting a radio wave oscillator carried by a worker by acquiring an oscillator identifier for identifying the oscillator by receiving a radio wave emitted by the oscillator;
generating oscillator detection information by associating the acquired oscillator identifier with a receiver identifier for identifying a receiver that has received the radio wave and timing information indicating a timing of receiving the radio wave;
acquiring detection period information that is obtained based on the oscillator detection information and that indicates a period in which the oscillator is continuously detected by the receiver;
determining whether the worker carrying the oscillator detected in the period has actually performed an operation in a workplace associated with the receiver that has detected the oscillator in the period, on the basis of a length of the period included in the detection period information;
performing a noise removal process of removing the worker from an operation performance in the workplace when it is determined that the worker has not actually performed the operation at the determining; and
managing an operation performance of the worker by analyzing the detection period information subjected to the noise removal process.

11. The personnel management method according to claim 10, wherein performing the noise removal process includes assuming, when determining that the worker has not actually performed the operation, that the worker has performed an operation in a workplace associated with a receiver that has detected the oscillator in a period indicating a previous timing or a subsequent timing, during the period included in the detection period information.

12. The personnel management method according to claim 11, wherein performing the noise removal process includes assuming, when determining that the worker has not actually performed the operation and if the same receiver has detected the oscillator in the periods indicating the previous timing and the subsequent timing, that the worker has continuously performed the operation in the workplace associated with the receiver that has detected the oscillator during the periods indicating the previous timing and the subsequent timing.

13. The personnel management method according to claim 11, wherein performing the noise removal process includes assuming, when determining that the worker has not actually performed the operation and if different receivers have detected the oscillator in the periods indicating the previous timing and the subsequent timing, that the worker carrying the oscillator has moved from a workplace associated with the receiver that has detected the oscillator in the period indicating the previous timing to a workplace associated with the receiver that has detected the oscillator in the period indicating the subsequent timing.

14. The personnel management method according to claim 10, wherein performing the noise removal process includes determining whether the worker has actually performed the operation in the workplace associated with the receiver that has detected the oscillator in the period, on the basis of a result of comparison between a length of the period included in the detection period and a threshold indicating a period for determining whether the worker has actually performed the operation in the workplace.

15. The personnel management method according to claim 10, wherein performing the noise removal process includes
acquiring the detection period information in which the period is separated by a predetermined information unit time,
referring to the detection period information every determination unit time that is a time including a plurality of information unit times, and
removing the worker from an operation performance in a workplace associated with a different receiver by assuming that the worker carrying the oscillator has performed an operation in a workplace associated with a receiver with a longest period among receivers that have detected the oscillator in the determination unit time.

16. The personnel management method according to claim 10, wherein performing the noise removal process includes
calculating an operation time for each worker in a predetermined period based on the detection period information, and
calculating and outputting an operation efficiency with respect to the operation time for each worker based on information on the period included in the detection period information subjected to determination of determining that the worker has not actually performed the operation.

17. The personnel management method according to claim 10, wherein managing the operation performance of the worker includes
analyzing the detection period information subjected to the noise removal process for a predetermined period, acquires information indicating a plan of an operation of the worker in the predetermined period, and
outputting notification information on a difference between an operation performance of the worker and the plan.
